(19) United States
(12) Patent Application Publication
(10) Pub. No.: US 2026/0341024 A1
(43) Pub. Date: Oct. 29, 2026

(54) MULTIFUNCTIONAL ASSISTANCE SYSTEM, IN PARTICULAR FOR PERSONS LIVING ALONE

(71) Applicants: Bettina Horster, Dortmund (DE); Thomas Horster-Moeller, Dortmund (DE)

(72) Inventors: Bettina Horster, Dortmund (DE); Thomas Horster-Moeller, Dortmund (DE)

(21) Appl. No.: 19/107,224

(22) PCT Filed: Aug. 31, 2023
(86) PCT No.: PCT/IB2023/000645

§ 371 Date: Feb. 27, 2025

(30) Foreign Application Priority Data
Aug. 31, 2022 (DE) 10 2022 121 975.5
Dec. 31, 2022 (DE) 10 2022 135 078.9

(51) Int. Cl. G06V 20/52; G08B 21/04

(52) U.S. Cl. CPC G06V 20/52; G08B 21/04

(57) ABSTRACT

Multifunctional assistance system, in particular for persons living alone, comprising a number of sensors which are distributed in a living area of a person using the assistance system for monitoring predefined activities and predefined parameters, a control and communication unit provided in the living area for communicating with the sensors and the person, a database in which non-sensor-based information about the person and at least two different alerting sequences are stored, and an evaluation unit for evaluating sensor data transmitted via the control and communication unit, wherein the evaluation unit can access the database and is configured to detect potential anomalies in the behavior and/or condition of the person from the sensor data, to classify the anomalies into at least two categories and, based on the categorization, to trigger an alert in accordance with at least one of the at least two alerting sequences.

### TECHNICAL FIELD OF THE INVENTION

The invention relates to a multifunctional assistance system, in particular for people living alone, and to a control and communication unit designed for this purpose.

### BACKGROUND OF THE INVENTION

Due to changing lifestyles and increasing age, the topic of self-determined living in old age has become increasingly relevant in recent years, both from a technical and a macroeconomic perspective. Even if they are mentally fit, many people experience at least certain physical impairments as they get older. Nevertheless, many people wish to live in their own apartment or house for as long as possible, especially as both nursing staff and care places are in short supply, and in many societies it is no longer common for three or even four generations to live under one roof.

In order to make life in familiar surroundings easier for people with certain physical limitations in particular, a wide range of technical products are already being offered, usually under the heading of Ambient Assisted Living (AAL, sometimes also referred to as Active & Assisted Living). Cogvis Software & Consulting GmbH, 1040 Vienna (www.cogvis.ai), for example, offers fall sensors without physical contact that can detect a person's movements in the rooms of an apartment using infrared measurements. On this basis, services and systems from this manufacturer offer automatic functions for fall detection and for raising an alert if a fall is detected. Similar functions are offered by the fall sensors from the Israeli company Vayyar (www.vayyar.com) that work without body contact.

US 2021/0074138 A1, the disclosure of which is referred to in particular with regard to the technical implementation of automated fall detection, as can also be used in the invention described here, discloses a room monitoring system that detects movements using infrared and other sensors, such as LIDAR sensors, and evaluates them with the aid of AI.

EP 1 566 782 A1 describes a fall detection system in which a home robot travels to a person who has fallen and communicates with them, e.g. to trigger one or more calls for help. The European standard DIN EN 50134-2 (VDE 0830-4-2) specifies requirements for triggering devices of corresponding call for help systems.

A concept for personalizing a fall detection algorithm for a specific person is known from EP 3 828 854 A1, in which sensor data together with feedback information is transmitted to an external device that generates update information for the fall detection algorithm. The update information is then used by the fall detector to update and thereby personalize the fall detection algorithm.

In addition, countless “smart home products” for an “intelligent” home are known, which can typically be operated wirelessly via the Internet and/or WLAN and exchange information with other devices, including, for example, light switches, heating controllers, sensors for monitoring the switching on of power consumers and adapter plugs for switching on power consumers. For voice control of such products, so-called smart speakers are known which make it possible to evaluate voice commands with AI support and convert them into corresponding control commands for the products.

To support the provision of services, functions or applications via the Internet with a portal and/or voice call function, in particular the following technical aids are known:

Keycloak is an open source software product published at www.keycloak.org to allow single sign-on with identity and access management for applications and services.

Apache Kafka is an open source software product published at kafka.apache.org to process data streams and to provide an interface for loading and exporting data streams to third-party systems.

Microsoft Azure is a cloud computing platform from Microsoft offered via http://azure.microsoft.com that can be used to offer applications and services.

At www.twilio.com, a cloud communication platform is offered having in particular a programming interface for making and receiving voice calls.

At www.traefik.io/traefik/, software and platform solutions are offered to make services and applications available, particularly from a portal.

### DISCLOSURE OF THE INVENTION

Although the known products certainly fulfill their respective purposes, an integrative solution that allows not only to detect falls but also other anomalies in a person's daily life and to also bundle various functions of assisted living in such a way that they can also be used simply and safely by non-tech-savvy people has been lacking to date. On this basis, the invention is based on the technical task of providing a corresponding assistance system which can not only bundle different functions but also allow them to interact synergistically, as well as a control and communication unit designed for such a system.

The problem is solved by a multifunctional assistance system with the features of claim 1 and a control and communication unit with the features of claim 24. Advantageous embodiments and further developments are the subject of the dependent claims.

An assistance system according to the invention comprises a number of sensors that are distributed in a living area of a person using the assistance system for monitoring predefined activities and predefined parameters. It is suitable for use in a person's own home as well as for use in nursing homes, hospitals and assisted living facilities.

Depending on the individual set-up of the system, it can also be used advantageously in hotels, for example. The term “living area” should therefore be interpreted broadly.

The system further comprises a control and communication unit provided in the living area for communication with the sensors and the person, a database in which non-sensor-based information about the person and at least two different alerting sequences are stored, and an evaluation unit for evaluating sensor data transmitted via the control and communication unit, wherein the evaluation unit can access the database and is configured to detect potential anomalies in the behavior and/or condition of the person from the sensor data, to classify the anomalies into at least two categories, and to trigger an alert based on the categorization according to at least one of the at least two alerting sequences. An “alerting sequence” is understood to be a computer-readable list of addresses and/or instructions stored in the database, which can be used by the evaluation unit to trigger an alert in such a way that certain persons and/or facilities are informed in a predetermined sequence. The term “alerting” is understood to mean any form of contact made to convey the information that an anomaly has occurred. An alert can thus be, for example, an automated call to a predetermined person and/or the sending of a text message to the same. If the person does not respond immediately or, depending on the detected anomaly, within a certain time interval, the alert is triggered for the next person or facility in the alert sequence.

In the event of certain behavioral and/or condition anomalies, different persons and/or facilities can also be informed simultaneously and/or in any case independently of whether the previous “link” in the alerting sequence has responded or not. For example, if the assistance system detects a potentially life-threatening situation, automated messages can be sent simultaneously and independently of each other to an emergency doctor, a janitor and a relative of the person concerned. At least one of the alerting sequences can be a dynamically updated alerting sequence, i.e. persons and/or facilities named in an update sequence can, for example, store and change information on their availability according to predeterminable criteria and/or it can be provided to locate at least certain persons provided in an alerting sequence and update the sequence in such a way that the person closest to the living area monitored by the assistance system is informed first.

The term “database” can be understood to mean any type of memory that is accessible to the evaluation unit and that could be physically distributed across different units.

The term “non-sensor-based information” refers to all types of data relevant to the respective use case that are not derived from the sensors located in the living area, such as the name and age of the person using the assistance system, their medical history, certain current medications, information about the person's hobbies and life history, etc., if applicable.

The term “anomalies in the person's behavior and/or condition” refers to all types of deviations from the person's “normal” behavior or condition. An anomaly in this sense can be, for example, a fall, but also unusually high blood pressure, a change in toilet behavior, sudden nocturnal activity, etc. However, an anomaly in this sense can also be a call for help from the person, which activates the assistance system via voice control to trigger an alert.

The term “classify into at least two categories” is understood here to mean that the detected anomalies are categorized according to predefined criteria, for example according to whether the respective anomaly indicates a potentially life-threatening condition of the person using the assistance system, so that immediate measures such as alerting an emergency doctor must be initiated, or according to whether the anomaly indicates a more gradual deterioration in the person's state of health, for example the onset of dementia. In the case of such anomalies that are not immediately life-threatening, “silent alerts” are triggered depending on the default settings, for example, to inform a doctor or nursing staff caring for the person using the assistance system that changes in the person's behavior indicate a deterioration in their state of health so that appropriate measures can be taken if necessary. In this sense, the assistance system can advantageously be understood as a diagnostic tool that enables the relevant specialist personnel to make diagnoses.

The term “evaluation unit” is not to be understood as a fixed physical unit, e.g. in the form of a dedicated computer, although it can also be realized in this way. Typically, the “evaluation unit” is a software component, preferably a dynamically changing, self-learning artificial intelligence that uses certain hardware to perform the desired evaluation and execution of the steps provided for in the alerting sequence. In this sense, it may be a cloud-based internet platform that is set up as an evaluation unit according to the invention by configuring it accordingly. The hardware may be a cluster or network of hardware units that may perform specific tasks, such as speech recognition or speech generation, or via which corresponding existing services and modules are accessed. The control and communication unit can be coupled with the evaluation unit in such a way that the evaluation unit also checks the status of the control and communication unit, e.g. the up-to-dateness of the software installed there, and initiates automatic updates if necessary. However, it may also be possible for the control and communication unit to carry out such checks itself. The invention advantageously offers an enormous degree of flexibility here, so that the assistance system can be easily and cost-effectively adapted to the respective application. If, for example, a person moves into a home that is already equipped with the assistance system and was previously occupied by a person who spoke a different language to the person moving in, the assistance system can simply access a different language module. If, for example, new sensors are installed in the monitored living area, the control and communication unit can automatically search for the software interfaces/communication protocols required for communication with the sensors. The evaluation unit collects and stores the data transmitted to it via the control and communication unit, preferably in a protected area, preferably cloud-based and in any case not on site in the monitored living area, so that a high level of data security can easily be guaranteed even if the control and communication unit fails. Communication between the evaluation unit and the control and communication unit is preferably wireless via at least one telecommunications network, whereby it can be advantageously provided that the control and communication unit is equipped with its own communication device, e.g. an LTE device, and does not require a router or a local network.

The multifunctional assistance system is designed especially for people living alone, but can also be used by couples, for example, without any restrictions. It is characterized by its excellent retrofitting capability and generally requires no costly conversion or installation measures. It can use standard sensors that communicate with the control and communication unit via standardized communication protocols.

With the multifunctional assistance system according to the invention, it becomes possible to “break up” previous “data silos” (of the individual sensors used, such as the fall sensors, and the individually used devices, such as smart speakers) and to view the data cumulatively so that new insights can be gained. For example, the assistance system according to the invention can be configured in such a way that it detects that the person using the system no longer eats regularly and/or stays in bed for a very long time after a change in medication. For example, a refrigerator sensor, a drawer sensor and a motion sensor that monitors the bed can be evaluated together with a medication schedule stored in the database. The assistance system makes it possible to check the so-called “ADLs” (Activities of Daily Living—the standard and measurement system used by the medical service to check a person's condition and whether they get a care level).

Further details and advantages of the invention will become apparent from the following purely exemplary and non-limiting description of an embodiment in conjunction with the drawing, which comprises three figures.

### BRIEF DESCRIPTION OF THE DRAWING

FIG. 1 shows schematically an apartment equipped with the assistance system according to the invention.

FIG. 2 shows schematically a combination of an evaluation unit with a control and communication unit.

FIG. 3 shows schematically a method according to the invention.

### DESCRIPTION OF PREFERRED EMBODIMENTS

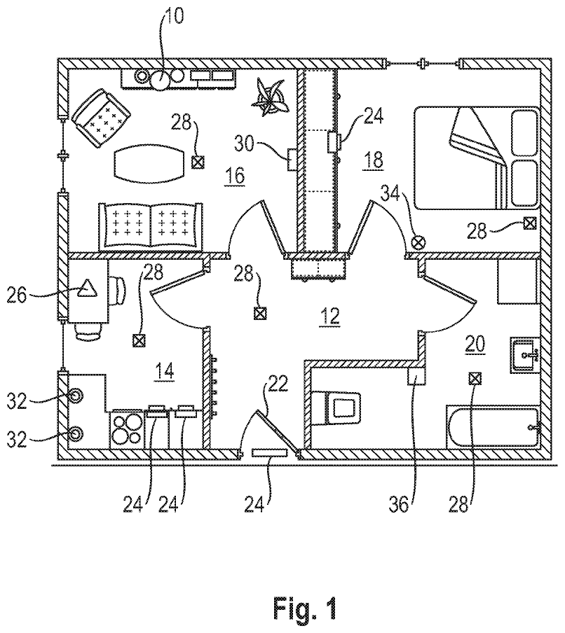

FIG. 1 shows an apartment in which a number of sensors are distributed for monitoring predefined activities and predefined parameters and in which a control and communication unit 10 is provided for communicating with the sensors and the person. Not shown are the database belonging to the assistance system and the evaluation unit.

The apartment shown has a hallway 12, a kitchen 14, a living room 16, a bedroom 18 and a bathroom 20. The apartment door 22 has a contact sensor 24. Corresponding contact sensors are also provided on certain cupboards and a refrigerator in the kitchen 14 and a cupboard in the bedroom 18. These sensors 24 may be used to monitor the closing and opening of the apartment and cupboard doors. A blood pressure monitor 26 is located in the kitchen 14. The blood pressure monitor 26 may be a mobile device that can be located in any room.

Motion detectors 28 are provided in all rooms. A fall sensor 30 is provided in at least one room, in this case the living room 16.

Two current sensors 32 are provided in the kitchen 14, which monitor the switching on of certain electrical appliances, for example a stove and an oven, or certain other kitchen appliances.

A night light 34 is provided in the bedroom 18.

A body weight scale 36 is provided in the bathroom 20. In this embodiment, devices and sensors 22-36 may be wirelessly coupled to the control and communication unit 10, so that the information recorded by them may be read out or, in the case of the night light 34, it may be activated by the control and communication unit 10.

The sensors shown, their positioning and their distribution to the individual rooms are purely exemplary in order to facilitate understanding of the invention. Further and/or other sensors may be provided, and these may be distributed differently to the rooms. With corresponding sensors, an assistance system can be realized that is configured according to claim 1 and that on addition may optionally also have the following features.

The control and communication unit 10 can be be configured to set up a local wireless communication network via which it can communicate with at least some of the sensors. This has the advantage that the sensors can be easily distributed in the living area to be monitored and positioned in such a way that they optimally fulfill their respective task. In addition, defective sensors can be easily replaced and new sensors can be easily integrated into the system without the need to lay cables.

Preferably, the evaluation unit is configured as a non-local computing unit, with which the control and communication unit 10 communicates wirelessly or, in particular, by wire. This has various advantages. For example, the hardware effort in the living area to be monitored can be minimized, the maintenance and updating of the evaluation unit can be simplified (typically the unit is formed by components located in a data center) and the data transmitted to the evaluation unit via the control and communication unit can be particularly secured, especially in a so-called “IoT” (Internet of Things) system. The algorithms used by the evaluation unit are typically processed in the cloud. If the control and communication unit in the monitored living area is defective or is accidentally disconnected from the power supply, no data can be lost. In addition, the control and communication unit is preferably configured so that it starts automatically when connected to a power supply and no time-consuming start-up procedures need to be carried out. In particular non-tech-savvy elder people sometimes disconnect the control and communication unit, for example to connect a different appliance such as a vacuum cleaner to the corresponding socket, and would be overwhelmed with special start-up procedures.

In a preferred embodiment, the control and communication unit is configured to check whether it is connected to a local power supply network and, if not, to trigger an alert according to a predetermined alerting sequence. Since the control and communication unit, as the central element of the local system, should always be online, this configuration ensures that interruptions in the activity of the control and communication unit are detected. For this purpose, the control and communication unit can have its own communication module and an energy storage unit in order to be able to communicate with the evaluation unit in the event of disconnection from the local power grid or failure of the power grid.

Alternatively or additionally, it may be provided that the evaluation unit is configured to permanently or intermittently check the functionality of the control and communication unit and to trigger an alert in accordance with a predetermined alerting sequence if a functional anomaly is detected

Preferably, the control and communication unit is configured to check the functionality of the sensors permanently or intermittently and to trigger an alert in accordance with a predetermined alerting sequence if a functional anomaly is detected. The testing of the sensors can be triggered by the evaluation unit as part of remote maintenance.

Preferably, the control and communication unit is configured to communicate with the sensors via various communication protocols, in particular via at least some of the following protocols: Wi-Fi, Bluetooth®, Zigbee®, Z-Wave, 6LoWPAN, RFID, Cellular IoT protocols, NB-IOT, 5G, NFC, LoRaWAN, LTE, protocols from the Infrared Data Association (IrDA), and IR remote control protocols from consumer electronics. These protocols may be stored in the control and communication unit or be available for retrieval in the evaluation unit. Ultimately, the only important thing is that commercially available sensors can be connected to the control and communication unit in such a way that the data they record can be forwarded to the evaluation unit without any major installation effort.

The control and communication unit typically comprises a microphone, a loudspeaker and a display, preferably a touch display, and thus allows auditory and visual communication with the person using the assistance system.

The sensors used preferably comprise sensors from at least two of the following types of sensors: motion sensor, presence sensor, fall sensor, temperature sensor, door opening sensor, window opening sensor, current flow sensor to certain electrical devices, weight sensor, blood pressure sensor, infrared sensor, ultrasonic sensor, LIDAR sensor, blood glucose sensor, medication box sensor, refrigerator sensor, toothbrush sensor, smoke detector, CO2 sensor. It should be noted that in an assistance system according to the invention, sensors that are actually “dumb” become “smart” because they suddenly have logic. For example, an electricity meter on the television can indicate that the person using the system is no longer keeping to their usual rhythm (e.g. watching the news at 8 p.m.). The electricity meter is thus given a logic indirectly, namely via the evaluation unit, and becomes smart in this sense.

Preferably, the evaluation unit is configured to include non-sensor-based data from the database when determining an anomaly and to output any changes in the non-sensor-based data as the context of the anomaly when an anomaly is detected. For example, information about a current medication may be stored in the database as non-sensor-based data. If an anomaly such as a change in sleep behavior is detected, the system can inform the person or unit to be alerted in accordance with the respective alerting sequence that the anomaly occurred at the same time or shortly after a change in medication.

Preferably, the evaluation unit is configured to use self-learning algorithms for evaluation. The system thus develops itself automatically further and adapts to new life circumstances of the person using the system.

In another preferred embodiment, the control and communication unit is configured for coupling with smart home control units. This advantageously allows the system to take over activities far beyond anomaly determination and the person using the system does not have to be familiar with different control units.

In a further preferred embodiment, the control and communication unit comprises at least one mobile communication device that may be connected to the evaluation unit and/or the control and communication unit and via which information about the person and/or the living area released to a user of the mobile communication device may be displayed. The mobile communication device may be part of at least one of the at least two alerting sequences. The communication device may be a standard smartphone and the user may be, for example, a close relative of the person using the system. An adult child can thus check at any time whether their mother in need of care is doing well, for example. Advantageously, the mobile communication device can also be configured to control the smart home control devices after appropriate authorization by the person using the assistance system. A son could, for example, control the heating in the living area when he brings his mother back from a visit so that the living area is at the desired temperature on arrival.

Preferably, the control and communication device is configured to communicate with the person according to predefined or variable criteria. The variable criteria may be criteria learned from the person's previous behavior and/or condition. Communication can therefore be established with the person if required and enabled, without the person having to actively request this. For example, certain emotional anomalies may be prevented or remedied. For example, if it is determined that the person using the system feels lonely, AI-supported conversations may be initiated automatically, the keeping of a gratitude diary (spoken and possibly automatically converted into writing) may be encouraged and the person may be motivated to remember the good things in life. Filtering in the form of a so-called sentiment analysis ensures that only positive thoughts are recorded. Activating morning and evening conversations may be held with AI support and the morning and evening may be made more positive with pleasant sayings. It is also possible to encourage the person to play memory-enhancing games that train the brain.

Preferably, the control and communication unit is also configured to be used as a telephone and/or videophone.

The assistance system is advantageously configured in such a way that a person can communicate with the system in natural language. This may be done using AI-supported chatbots, wherein the assistance system advantageously allows chatbots to be used without the need for special reprogramming.

If the assistance system communicates with the person automatically, the communication may concern one topic in particular from the following list of topics: queries about detected anomalies, reminders about specific appointments and actions, rehabilitation measures, preventive measures, positive psychological intervention, commissioning errands. However, this list of topics is by no means exhaustive. For example, religious or nutrition-related topics can also be discussed with AI support. Reminders for appointments or actions, e.g. eating, drinking, taking medication, can also be issued verbally and appear simultaneously on the screen of the control and communication unit. The reminder may be marked as completed by confirming it.

Preferably, the evaluation unit is configured to use current and historical sensor data to draw conclusions about at least some of the following conditions and abilities of the person using the assistance system: state of health, emotional state, cognitive abilities, ability to live independently.

The assistance system according to the invention makes it possible to evaluate information about the condition and behavior of the person using the system to form an overall picture. The information may be shared with other stakeholders such as relatives, doctors or care services.

As conversations are often difficult to manage for people who can no longer hear well, the control and communication unit may be provided with extra powerful speakers and display all dialog on the screen in clearly legible text.

Thanks to the voice assistant and the internet connection, the resident can also easily regain access to so-called “digital participation”, even if the resident is not (or no longer) able to handle IT. Generative AI enables the control and communication unit to conduct natural language dialogs and provide information on topics such as nutrition or other advice. Biographical work based on a medical history form is also possible. Here, the system gives advice on how one may behave. Memories can also be processed.

There are several modes in which one can communicate with the control and communication unit. The system thus makes a significant contribution to coping with everyday life in a self-determined and safe manner despite certain health restrictions, while at the same time enabling relatives, caregivers, etc. to be contacted quickly in emergency situations. In doing so, fun and interaction do not have to be neglected. Long-term monitoring of the behavior of the person using the system may be used to identify cognitive disorders. If a person gets up more and more frequently at night and walks around the home, they probably have problems structuring their day, which may indicate a possible dementia or Parkinson's disease. An integrative approach is a special feature of the system. It is a holistic solution that combines information on activity and behavioral profiles to sound the alert or signal the need for support at the right moment. For example, there are also prompts or instructions to take medication at the right time, turn off the stove or have a drink. The focus here is on the prevention concept. It is clear that the system not only allows acute danger prevention, but also the observation of the course of a person's behavior and/or condition. Changes in behavior are recorded during long-term observation in order to document the person's status. Dialogs recorded with consent may be used in long-term observation to see how speech changes. Based on the status analysis, an expert can then assess whether there is a change that needs to be checked by a specialist. The system takes a holistic approach and provides support in coping with everyday life.

Information on the state of health may be displayed as a dashboard and/or as a traffic light system. The person using the system can decide who sees which data. For example, many people do not want their children to see what they are doing in detail (e.g. number of toilet visits).

The assistance system can support both prevention and rehabilitation, e.g. after strokes, e.g. with activating games and speech exercises.

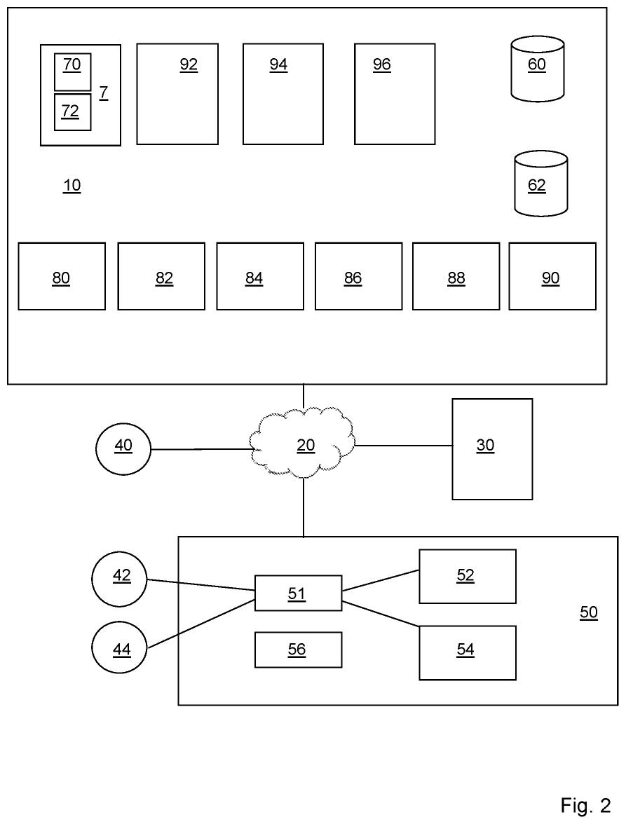

FIG. 2 shows a system with one of several possible configurations according to the invention. An evaluation unit 10 is connected via a telecommunications network 20 or WAN (Wide Area Network) with smartphones as alert receiving devices 30 and body contactless fall sensors 40 and a control and communication unit 50. To simplify the illustration, only one of the alert receiving devices and only one of the fall sensors are shown in FIG. 2. It is should be understood that the evaluation unit 10 is configured to interact with a large number of control and communication units in different living areas. The control and communication unit 50 has an audio input and audio output device 52 with loudspeaker and microphone, a processor 51 in connection with a known memory unit 56 for reading in and out data and commands, and a touch screen 54 for further input and/or output via display.

The evaluation unit 10 comprises:
a database 60 in which residential addresses are associated to the control and communication unit 50 and to at least one of the fall sensors 40 for linking each of the fall sensor outputs and the audio outputs and inputs of the control and communication unit to one of the residential addresses;
an IoT hub 7 with APIs for the fall sensor outputs 70, only one of which is shown in FIG. 2,
a speech processing unit 80 for converting a stored text sequence into audio output and the audio input into another stored text sequence for voice control,
an alert unit 82 utilizing the APIs for the fall sensor outputs 70 and implementing the following functions:
   receiving the sensor outputs using the APIs for the fall outputs 70,
   triggering a voice dialog on the control and communication unit 50 according to the alerting sequence and, if necessary, sending a call for help with indication of the residential address according to the link, in case at least one condition is fulfilled, comprising the condition that a received one of the fall sensor outputs signals an alert, in particular a fall alert,
   cancel the alert when help refusal is detected,
   sending a call for help to the alert receiving device 3 according to the scheduling.

In the embodiment shown, the fall sensor 40 is part of a fall detection system set up with the network 20, and the fall sensor outputs are evaluations of, for example, infrared images from a sensor in the home. The API 70 is then configured as a gateway for receiving the evaluations by the evaluation unit.

The evaluation unit 10 also includes a helper database 62 in which each residential address is associated with a list of helper contacts with rank order and helper availability times. The evaluation unit 10 is configured with a helper database module 94 to allow authorized form-based remote access to the helper database 62 and thus to serve as a portal for authorization-dependent access to the helper database 62 for deletion, modification, reading and/or addition. This also allows helper availability periods to be managed, in particular entered.

The function of sending the call for help is set up
to create a selection of the helper contacts in the list whose assigned helper availability times include,
to send the call for help and request a confirmation to one of the alert receiving devices 30 according to the highest-ranking helper contact in the selection,
to check the receipt of the confirmation and the number of helper contacts in the selection and
to update the selection if the number is greater than 1 and if there is no confirmation for a predetermined period of time, by removing an entry corresponding to the highest-ranking helper contact,
to repeat the sending of the call for help and the request for confirmation.

With wireless connection to the control and communication unit 50, further sensors 42, 44 for sending further sensor outputs are linked to the processor of the control and communication unit, as are the audio input and audio output device 52. In the database, the link is further a link of the further sensor outputs to one of the residential addresses. The evaluation unit 10 also comprises APIs for the further sensor outputs 72, of which only one is shown in FIG. 2.

The evaluation unit 10 also comprises an analysis unit 84 implementing the following functions:
creating profiles specific to addresses among the residential addresses, based on the link and with the other sensor outputs and, if applicable, the fall sensor output, and
recording and classifying of profile changes over time.

The other sensors 42, 44 are sensors for monitoring the closing of doors and/or the switching on of power consumers such as a stove.

The evaluation unit 10 also comprises a classification adjustment module 96 to serve as a portal for authorization-dependent access to the classifications for reading and/or to factors of the classifications for reading, modifying, deleting or supplementing by authorized form-based remote access.

The function of triggering a voice dialog and providing a call for help is advantageously a function that requires the presence of the condition that the classification signals danger.

The evaluation unit 10 comprises a machine learning unit 86 that implements the following functions:
capturing feedback information by capturing, for a set of addresses among the residential addresses, the deletion or addition of factors of the classifications,
updating the factors of the classifications for the set of addresses,
repeating the collection of feedback information and updating the factors of the classifications with iteration of the factors of the classifications to minimize an extent of the detected cancellation of the alert and/or deletion or addition of the factors of the classifications.

The evaluation unit 10 also comprises an appointment reminder unit 88 for reminding appointments by means of the audio output. The server unit 1 also comprises a voice input unit 90 with a function, for example, to supplement the profiles by voice input. The evaluation unit 10 is also set up as a portal for form-based remote settings of queries for voice input in order to supplement the profiles or to be able to adjust classifications, in particular associated factors or weightings, via a classification module 96 using a portal in a form-based and authorization-dependent manner. The evaluation unit 10 is also set up with the appointment reminder unit 88 as a portal for setting appointment reminders in an authorization-dependent manner. For example, voice prompts for blood pressure readings may be set up or reminders for food and/or fluid intake.

In the control and communication unit 50, the processor 51 is connected to a memory such as a flash memory 56 with the required operating system, drivers and applications.

In this embodiment example, the evaluation unit 10 comprises a chatbot 92 for interacting with the audio output and input unit 52, in particular for voice games.

The control and communication unit 50 here also comprises a touchscreen 54 as a display (not shown).

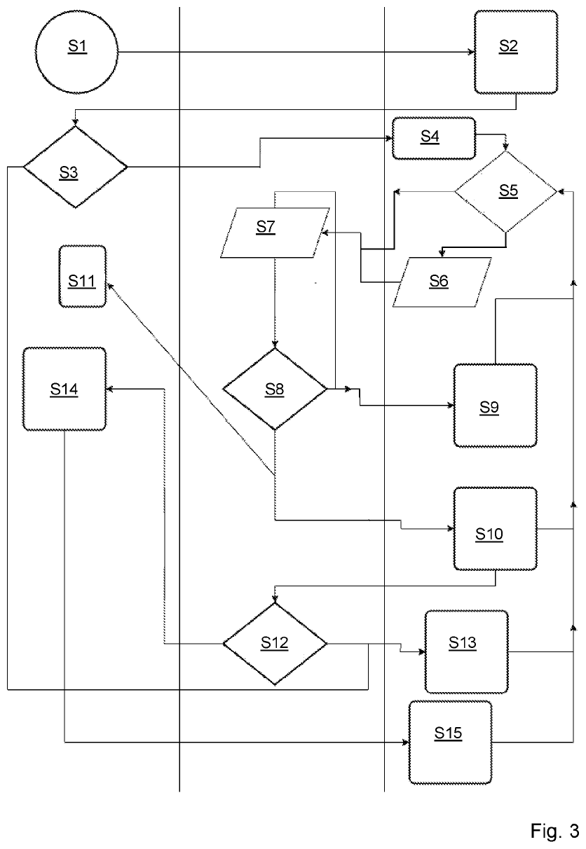

FIG. 3 is a process diagram consistent with a process according to the invention. The process diagram is divided by vertical lines into
processes in an apartment, shown on the left,
processes of interaction with an assistant outside the home, shown in the middle, and
processes in the evaluation unit 10 shown in FIG. 1; shown on the right.

The method illustrated in FIG. 3 is a method for operating the network of hardware units schematized in FIG. 2, wherein data connections are provided from the fall sensor 40 to the evaluation unit 10, between the control and communication unit 50 and the evaluation unit 10, and from the latter to the alert receiving device 30. The following steps are carried out using the alerting unit 82:
S1 receiving the fall sensor outputs using the APIs for the fall outputs 70,
S2 triggering a voice dialog on the control and communication unit 50 according to the link and scheduling a sending of a call for help indicating one of the residential addresses according to the link, in the presence of at least one condition comprising the condition that a received one of the fall sensor outputs signals a fall,
S3 executing the voice dialog on the control and communication unit 50 when accessing a speech processor unit 80,
S13 cancellation of scheduling by the voice control when the next text sequence is recognized as a help rejection,
S6 sending the call for help to the alert receiving device 3 according to the scheduling.

A fall sensor 40 provides a fall sensor output in step S1 that signals a fall event. A system in which a sensor unit in the home is connected with a cloud-based fall sensor platform, which ultimately provides the fall sensor output in step S1, can also be used for fall sensor output.

For receiving the fall sensor output, an API 70 is provided in the evaluation unit, which enables the evaluation unit to continue with the S2 triggering of a voice dialog on the control and communication unit 50, which is located in the same apartment as the fall sensor 40 or its sensor unit, based on the fall sensor output. The database 60 uses a link to ensure that the voice dialog is triggered precisely on this control and communication unit 50, which is located in this apartment. This takes place under the condition that one of the received fall sensor outputs signals a fall. The voice dialog is then executed in step S3 on this control and communication unit 50. For this purpose, audio streaming is set up between control and communication unit 50 and evaluation unit 10. The voice dialog is thus executed in step S3 by access of the control and communication unit 50 to the speech processor unit 80. The speech processor unit 80 can also be one that interacts with a cloud-based speech recognition service. The voice dialog is executed in step S3 on this control and communication unit 50 in order to be able to provide feedback from a person in the home to the evaluation unit 10. An alert confirmation is received by the evaluation unit 10 in step S4 both when help is requested as feedback and when a predetermined period of time has elapsed after step S3 has been triggered. As described above, the evaluation unit 10 is configured with a helper database 62 in which each residential address is assigned a list of helper contacts with ranking order and helper availability times. When the alert acknowledgement is received, a selection of the currently available helper contacts from the list is created in step S4.

In step S6, the call for help is then sent and a confirmation is requested from one of the alert receiving devices corresponding to the highest-ranking helper contact in the selection according to the ranking. For this purpose, an email and an SMS are sent to an assistant's smartphone and received there in step S7.

According to the sequence described above, a scheduling of a sending of a call for help with indication of one of the residential addresses according to the link is thus carried out if at least one condition is present, comprising the condition that one of the received fall sensor outputs signals a fall. Advantageously, the scheduling can also be brought forward when the further stored text sequence is recognized as a help request.

Using a browser-based application on an assistant's smartphone, the assistant sends in step S8 the following:
a confirmation that triggers step S10 in the evaluation unit 10 or
a rejection that triggers step S9 in the evaluation unit 10.

Alternatively, a rejection that triggers step S9 in the evaluation unit 1 takes place automatically via the process flow of step S7 bypassing step 8, namely after a predetermined period of time, during which step S10 was not triggered, has elapsed after step S6.

Alternatively, executing the voice dialog S3 with voice control makes it possible to cancel the scheduling by voice control when a help rejection is detected. In this way, voice control in step S13 cancels the scheduling of a call for help even after it has been sent. A triggered alert may be marked as a false alert or non-critical. In addition, it is provided that the scheduling of the sending of a call for help may be canceled in step S12 on a smartphone in step S13, even after it has been sent. Scheduling means specifying that alert messages are to be sent in accordance with step S6 and from what point in time.

In addition, it is provided that by the entering S14 on the touch screen 54 provided on the control and communication unit 50 or, alternatively, on a button provided on the control and communication unit or by the voice control in step S15, the scheduling of a sending of a call for help is canceled, if necessary also after sending.

In step S5 it is checked whether the scheduling has been canceled. If the scheduling has not been canceled, step S5 checks whether the number of helper contacts in the selection is greater than 1. In step S5, the selection is updated if the number is greater than 1 and if there is no confirmation for a predetermined period of time as signaled by step S9. The update is performed by removing an entry corresponding to the highest-ranking helper contact, which is then followed by step S6 in order to alert the next helper, whereas otherwise, if the number is 1, step S6 is bypassed and the already alerted helper is alerted again.

Functions or steps are thus implemented in the evaluation unit
for checking the receipt of the confirmation and the number of helper contacts in the selection and
for updating the selection if the number is greater than 1 and if there is no confirmation for a predetermined period of time, by removing an entry corresponding to the highest-ranking helper contact,
for repeating the sending of the call for help and the request for confirmation.

A confirmation in step S8 also triggers the displaying S11 of a message on the touchscreen 54 of the control and communication unit 50 about the confirmation of the assistant. In step S10, the scheduling of the sending of a call for help is canceled and the assistant is further prompted to consult by a message on the smartphone. Canceling the scheduling of a call for help ensures that no further alerts may be sent with step S6 after step S5. A function or a method part may also be provided to ensure after canceling scheduling of a dispatch of a call for help that after step 5 no further alert dispatch can take place with step S6 and that a message to all assistants, for whom step S6 has been executed and from whom no confirmation has been received via step S10, is send. These assistants can thus be informed that an alert has been resolved.

Consultation takes place via a voice call between the smartphone and the control and communication unit 50, which is also equipped with a voice call and telephone function set up for this purpose. The assistant then decides and either triggers step S13 with the smartphone or goes to the apartment. After assistance has been provided, input S14 is then made on a touchscreen 54 provided on the control and communication unit or, alternatively, on a button provided on the terminal device or by voice control, which input in step S15 cancels the scheduling of the sending of a call for assistance (possibly also after a call for assistance has been sent).

The server device, in particular said portal and/or respective form-based inputs via the units or modules 88, 94 may be arranged for one or more of the following features or functions:
editing user profile including two-factor authentication,
set appointments including language reminder,
set medication including voice reminder,
view medication plan,
set drinking reminder including voice reminder or drinking sound,
data acquisition and evaluation, especially of sensor outputs,
manage sensor technology, in particular via classification adjustment module 96,
monitor vitality values using the sensor outputs,
manage authorizations for relatives and care services,
event analysis based on the sensor outputs,
alert processing,
user administration,
alerting sequence management,
device management,
remote access to control and communication units, especially via teleport,
remote software update on control and communication units,
data migration.

In addition, the times of each readable sensor output, in particular fall sensor output, can also be captured by the evaluation unit 10, stored and made available in the portal.

In the evaluation unit 10 APIs for voice interfaces may be provided, in particular for voice control, such as
API Twilio SMS, WhatsApp and phone calls,
API Vayyar fall sensor,
API Withings or Nokia.

The following techniques, features and products can be used to implement the evaluation unit 10:
domain driven design,
distributed streaming solution with Kafka including data replication, data aggregation, partitioning, load balancing and fail-safety,
identity management with Keycloak including 2FA, OpenID Connect, OAuth2, authentication and authorization,
microservice architecture with Kubernetes and Docker,
secure connection of end device and cloud via Azure IoT hub,
automatic data synchronization between portal and end device,
device simulator,
data analysis/AEDLs,
quartz system scheduler.

Via step S11 described above, it is displayed, preferably in a transparent manner, how an alerting sequence is processed and who will take care of this case.

For the sensor outputs, interfaces via Bluetooth to a scale, a blood pressure monitor and a blood glucose meter may be implemented as examples. The vitality data may be transmitted completely independently of the device via the audio input and audio output device and with the help of the speech processor unit 80. This promotes the participation effect, personal responsibility and offers the possibility of continuing to use familiar devices.

Example texts for the alerts according to step S6 described above are:
Fall: “Fall alert at Ms. Maria Mustermann, Beispielweg 14, 12345 Irgendwo, time: 19:20 12.08.2020, phone +49 1234 567891011 or +49 9876 543210. Will you take care of it? 1=Yes, 9=No”
Dangerous situation: “Noticeably long inactivity at Ms. Maria Mustermann, Beispielweg 14, 12345 Irgendwo, time: 19:20 12.08.2020, Tel. +49 1234 567891011 or +49 9876 543210. Will you take care of it? 1=Yes, 9=No”
Vitality values: “Unusually high blood pressure 167/102 at Ms. Maria Mustermann, Beispielweg 14, 12345 Irgendwo, time: 19:20 12.08.2020, phone +49 1234 567891011 or +49 9876 543210. Will you take care of it? 1=Yes, 9=No”

With step S6 advantageously an alert can optionally be sent to another application via API. The German emergency service Malteser uses its own system to manage incoming emergency calls. This can then be addressed via the configurable API, and an API for reporting back the alerts can also be provided.

In addition to the touch screen 54, the evaluation unit 10 can advantageously also control outputs to smart home devices such as lighting devices via the control and communication unit 50, also in response to some of the sensor outputs and/or to voice inputs into the audio input and output unit 52 and possibly also according to settings offered with the evaluation unit 10 via portal in a form-based and authorization-dependent manner.

1. A multifunctional assistance system, in particular for people living alone, comprising
a number of sensors distributed in a living area of a person using the assistance system to monitor predefined activities and predefined parameters,
a control and communication unit provided in the living area for communication with the sensors and the person,
a database with non-sensor-based information about the person and at least two different alerting sequences, and
an evaluation unit for evaluating sensor data transmitted via the control and communication unit,
wherein the evaluation unit can access the database and is configured
to detect potential anomalies in a behavior and/or condition of the person from the sensor data,
to classify the anomalies into at least two categories and
to trigger an alert based on a categorization in accordance with at least one of the at least two alerting sequences.

2. The multifunctional assistance system according to claim 1, wherein the control and communication unit is configured to set up a local wireless communication network via which it can communicate with at least some of the sensors.

3. The multifunctional assistance system according to claim 1, wherein the evaluation unit is configured as a non-local computing unit with which the control and communication unit communicates wirelessly or by wire.

4. The multifunctional assistance system according to claim 1, wherein the control and communication unit is configured perform at least one of:
check whether it is connected to a local power supply network and, if not, to trigger an alert according to a predetermined alerting sequence, and
communicate with the sensors via various communication protocols, in particular via at least some of protocols selected from: Wi-Fi, Bluetooth®, Zigbee®, Z-Wave, 6LoWPAN, RFID, Cellular IoT protocols, NB-IOT, 5G, NFC, LoRaWAN, LTE, Infrared Data Association (IrDA) protocols, and IR remote control protocols from consumer electronics.

5. (canceled)

6. The multifunctional assistance system according to claim 1, wherein the control and communication unit comprises a microphone, a loudspeaker and a display, preferably a touch display.

7. The multifunctional assistance system according to claim 1, wherein the sensors comprise sensors selected from at least two of: motion sensor, presence sensor, fall sensor, temperature sensor, door opening sensor, window opening sensor, current flow sensor to certain electrical devices, weight sensor, infrared sensor, ultrasonic sensor, LIDAR sensor, blood pressure sensor, blood glucose sensor, medication box sensor, refrigerator sensor, toothbrush sensor, smoke detector, CO2 sensor.

8. The multifunctional assistance system according to claim 1, wherein the evaluation unit is configured to include non-sensor-based data from the database in determining anomalies and, when an anomaly is detected, to output any changes in the non-sensor-based data as a context of the anomaly.

9. The multifunctional assistance system according to claim 1, wherein the evaluation unit is configured to use self-learning algorithms for evaluation.

10. The multifunctional assistance system according to claim 1, wherein the control and communication unit is configured for coupling with smart home control devices.

11. The multifunctional assistance system according to claim 1, wherein the multifunctional assistance system comprises at least one mobile communication device which can be connected to the evaluation unit and/or the control and communication unit and via which information about the person and/or the living area released to a user of the mobile communication device can be displayed.

12. The multifunctional assistance system according to claim 11, wherein the mobile communication device is part of at least one of the at least two alerting sequences.

13. The multifunctional assistance system according to claim 11, the control and communication unit being is configured for coupling with smart home control devices, and
wherein in that the mobile communication device is configured to control the smart home control devices after corresponding authorization by the person using the multifunctional assistance system.

14. The multifunctional assistance system according to claim 1, wherein the control and communication unit is configured to communicate with the person according to predefined or variable criteria.

15. (canceled)

16. (canceled)

17. The multifunctional assistance system according 1, wherein the variable criteria are criteria learned from a previous behavior and/or state of the person.

18. The multifunctional assistance system according to claim 1, wherein the control and communication unit has its own communication module and an energy storage unit in order to be able to communicate with the evaluation unit in the-an event of disconnection from a local power grid or failure of the local power grid.

19. The multifunctional assistance system according to claim 1, wherein the evaluation unit is configured to perform at least one of
permanently or intermittently check a functionality of the control and communication unit and, if a functional anomaly is detected, triggering an alert according to a predetermined alerting sequence, and
draw conclusions from current and historical sensor data about at least some of a number of states and abilities of the person using the assistance system, selected from: state of health, emotional state, cognitive abilities, ability to live independently.

20. The multifunctional assistance system according to claim 1, wherein the control and communication unit is configured to permanently or intermittently check a functionality of the sensors and, if a functional anomaly is detected, to trigger an alert according to a predetermined alerting sequence.

21. (canceled)

22. The multifunctional assistance system according to one claim 1, wherein the control and communication unit is configured to be used as a telephone and/or videophone.

23. The multifunctional assistance system according to claim 1, wherein the at least one alerting sequence is a continuously updated alerting sequence.

24. A control and communication unit for an assistance system according to claim 1.
